(19) United States
(12) Patent Application Publication
(10) Pub. No.: US 2016/0072677 A1
(43) Pub. Date: Mar. 10, 2016

(54) Systems and Methods for Connecting Home Area Network Devices to Smart Meters and Utility Accounts

(71) Applicants: Abhay Gupta, Cupertino, CA (US); Vivek Garud, Cupertino, CA (US)

(72) Inventors: Abhay Gupta, Cupertino, CA (US); Vivek Garud, Cupertino, CA (US)

(21) Appl. No.: 14/845,198

(22) Filed: Sep. 3, 2015

Related U.S. Application Data
(60) Provisional application No. 62/045,700, filed on Sep. 4, 2014.

(51) Int. Cl. H04L 12/24; G06Q 30/02; G06Q 50/06; H04L 29/08; H04L 12/28

(52) U.S. Cl. CPC H04L 41/12; H04L 67/12; H04L 12/2807; H04L 41/0886; G06Q 50/06; G06Q 30/0283

(57) ABSTRACT

The present invention is generally directed to systems and methods for pairing energy monitoring devices with energy metering devices. Some embodiments disclose a method of pairing of an energy monitoring device with an energy metering device with limited user action, the method transacted using an pairing device in communication with the monitoring device and the metering device, the method including: detecting, using the pairing device, the monitoring device and at first identifier associated therewith; retrieving a second identifier associated with the monitoring device, based at least in part on the first identifier; identifying by the pairing device, the metering device and a metering device identifier associated therewith; providing by the pairing device, the first identifier and the second identifier to the metering device; and pairing the detected monitoring device with the identified metering device.

### RELATED APPLICATIONS

This application claims the benefit of U.S. Provisional Patent Application Ser. No. 62/045,700 filed on Sep. 4, 2014, which is incorporated herein by reference in its entirety.

### BACKGROUND

The present subject matter described herein, in general, relates to pairing electronic devices, and more particularly but not exclusively to methods and devices to simplify pairing of an energy monitoring device with an energy metering device

Smart meters produce unprecedented amounts of home energy usage data. Users with a smart meter attached to their home may have the ability to communicate their energy usage information in short time intervals to an external third party, such as their utility or a monitoring or analytics service. Such short time interval data may assist with faster billing, quicker notification of outages, and/or fewer in-person maintenance visits required by the utility. However, smart meter data may be limited by data granularity and frequency of communication with the utility.

Increased granularity may, for example, be useful for disaggregating appliance-level energy usage information for that user. Energy disaggregation, (also known as Non-Intrusive Load Monitoring (NILM)) is known in the art. Energy disaggregation may enable the breakdown of electricity usage for a home or business without entering the premises or applying any sub-metering devices on the individual appliances/devices/loads inside the premises. The basic energy disaggregation process may involve generating and using appliance load signatures to extract energy consumption of individual loads from the whole house load profile data.

Increased granularity received from the energy utility and/or a smart meter may, for example, be useful for disaggregating appliance-level energy usage information for that user. A common application of energy disaggregation is its use for making consumers aware of their energy spending breakdown and identifying appliance specific inefficiencies.

In such situations, an in-home energy monitoring device may be connected to a customer's smart meter via a Home Area Network (HAN). The energy monitoring device may be used to supplement and/or augment data that a smart meter may provide. However, in order to utilize a HAN, such generally may be registered with an energy utility, paired with the specific customer's smart meter, and paired with the specific customer's energy rate plan.

This process generally requires several manual steps to be performed by the user, which may often be frustrating and may lead to process abandonment. For example, the user may have difficulty locating and/or identifying the MAC ID or Install Code of the energy monitoring device or HAN, and may give up on activating this in-home device. Abandonment of the process may cause the customer to lose out on benefits of an increased level of data granularity that the energy monitoring device may provide.

Accordingly, there is a need for easy, efficient, and simple connection and pairing of a HAN device (such as the energy monitoring device) with a customer's smart meter and/or energy utility account.

In accordance with some embodiments of the present invention, aspects may include a method of pairing of an energy monitoring device with an energy metering device with limited user action, the method transacted using an energy disaggregation pairing device in communication with the energy monitoring device and the energy metering device, the method comprising: detecting, using the energy disaggregation pairing device, the energy monitoring device and at first monitor device identifier associated therewith; retrieving, using the energy disaggregation pairing device, a second monitor device identifier associated with the energy monitoring device, based at least in part on the first monitor device identifier; identifying by the energy disaggregation pairing device, the energy metering device and a metering device identifier associated therewith; providing by the energy disaggregation pairing device, the first monitor device identifier and the second monitor device identifier to the identified energy metering device; and pairing by the energy disaggregation pairing device, the detected energy monitoring device with the identified energy metering device.

In accordance with some embodiments of the present invention, other aspects may include an energy disaggregation pairing device comprising: one or more hardware processors; a memory coupled to the one or more hardware processors storing instructions, that when executed by the one or more hardware processors, causes the one or more hardware processors to perform operations comprising: detecting, using the energy disaggregation pairing device, the energy monitoring device and at first monitor device identifier associated therewith; retrieving, using the energy disaggregation pairing device, a second monitor device identifier associated with the energy monitoring device, based at least in part on the first monitor device identifier; identifying by the energy disaggregation pairing device, the energy metering device and a metering device identifier associated therewith; providing by the energy disaggregation pairing device, the first monitor device identifier and the second monitor device identifier to the identified energy metering device; and pairing by the energy disaggregation pairing device, the detected energy monitoring device with the identified energy metering device.

In accordance with some embodiments of the present invention, still other aspects may include a non-transitory computer readable medium storing instructions for simplifying pairing of at least one energy monitoring device with at least one metering device, that when executed by the one or more hardware processors, cause the one or more hardware processors to perform operations comprising: detecting, using the energy disaggregation pairing device, the energy monitoring device and at first monitor device identifier associated therewith; retrieving, using the energy disaggregation pairing device, a second monitor device identifier associated with the energy monitoring device, based at least in part on the first monitor device identifier; identifying by the energy disaggregation pairing device, the energy metering device and a metering device identifier associated therewith; providing by the energy disaggregation pairing device, the first monitor device identifier and the second monitor device identifier to the identified energy metering device; and pairing by the energy disaggregation pairing device, the detected energy monitoring device with the identified energy metering device.

The foregoing summary is only illustrative in nature and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates an exemplary flow of identifying a HAN device, in accordance with some embodiments of the present invention.

FIG. 2 depicts an exemplary flow of pairing a HAN device with a smart meter, in accordance with some embodiments of the present invention

FIG. 3 is a flowchart that illustrates an exemplary method for facilitating simplified pairing between energy monitoring device and energy metering device in accordance with some embodiments of the present invention.

FIG. 4 illustrates an exemplary method of registration of the energy monitoring device and the energy metering device with energy utility is shown in accordance with some embodiments of the present invention.

FIG. 5 illustrates an exemplary environment in which an energy disaggregation pairing device may interact with various entities in accordance with some embodiments of the present invention.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure. In addition, note that the order of steps of any process or method discussed herein or illustrated in the figures is exemplary and not to be construed as limiting.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Embodiments of the present disclosure are directed to method, computer readable medium, and device for simplifying pairing of at least one energy monitoring device with at least one energy metering device. In general, some embodiments of the present invention may provide a number of advantages. For example, the energy monitoring device may be used to communicate directly with a smart meter and convey information—which may be, for example, at a higher granularity—to an energy utility or third party. In this manner, higher quality data may be captured rather than what may be periodically captured from the smart meter. Devices and methods in accordance with some embodiments of the present invention may be utilized to increase the ease-of-use of in-home smart meter related devices.

### Pairing (FIG. 2)

Systems and methods in accordance with some embodiments of the present invention may be utilized to increase the ease-of-use of in-home smart meter related devices. This may be accomplished by (i) automating the HAN device and smart meter pairing process and (ii) automatically detecting the relevant customer's rate plan. These steps may in turn be performed in a variety of manners, including but not limited to: IP address matching, scanning and optical character recognition of a user's utility bill, or directly via a web interface.

Pairing may be accomplished by using a MAC (media access control) ID or install code, and associating the same with a customer's smart meter (for example, a wireless Zigbee smart meter). As discussed herein, systems and methods of the present invention may automatically detect the in-home HAN device when it is powered on by matching the IP addresses of the router connected to the HAN device as well as the computer/smartphone used to install the device. Thereafter, the HAN device may be paired with the proper smart meter.

In accordance with some embodiments, the user may take a picture of the device label, and optical character recognition (OCR) may be utilized to determine the relevant information to pair with the proper smart meter (e.g., the device Zigbee MAC ID and/or install code).

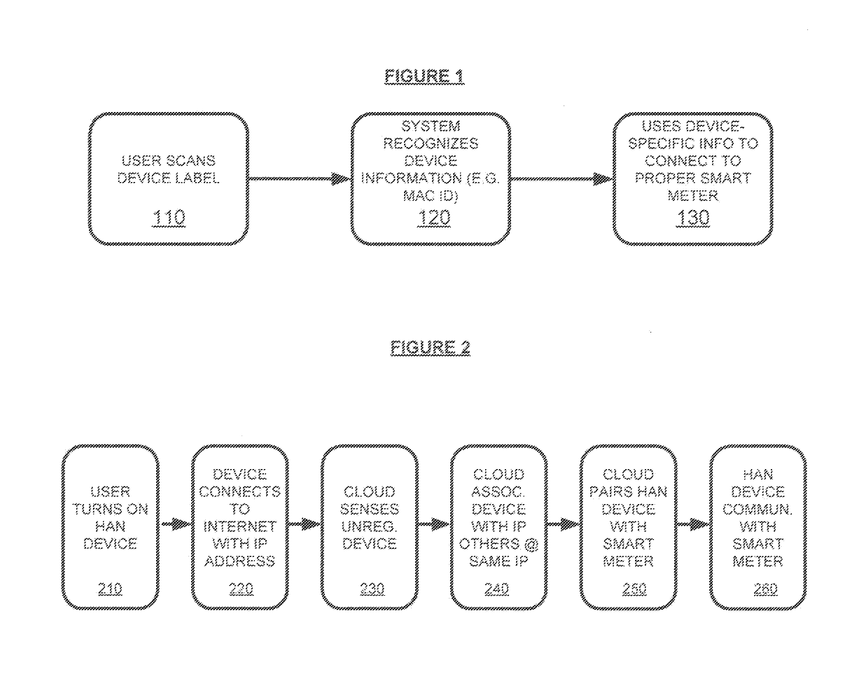

For example, with reference to FIG. 1, a simplified manner of identifying a HAN device and/or smart meter is disclosed. At 110 a customer may scan a label of the HAN device. The label may set forth various identifying information (for example, the MAC ID). Once scanned and sent to the processor, at 120 the processor of the system may recognize the device (for example, by performing optical character recognition on the captured image, or by identifying an ID associated with a machine readable indicia, such as a bar code or QR code). At 130, the device specific information conveyed in the image may be utilized by the processor to pair the HAN device with the proper smart meter.

With reference to FIG. 2, a process flow in accordance with some embodiments of the present invention will now be discussed. At 210 a customer or user may receive and turn on a HAN device (e.g., an energy monitor). At 220 the HAN device may connect to the internet, display its IP address, and contact the system of the present invention (which may be, as illustrated, cloud-based). At 230 the cloud or processor may sense or identify the unregistered device, and at 240 the cloud or processor may associate the HAN device with other devices transmitting from the same IP address. For example, the HAN device may be associated with a customer's computer or smartphone. At 250 the processor may determine the associated smart meter, and may pair the HAN device with the smart meter. At 260, once paired, the HAN device may begin to communicate with the smart meter. For example, if the HAN device is an energy monitor, the monitor may begin to communicate with the smart meter to capture high resolution data, real-time or near real-time data, and/or higher quality data than may be recorded by or available from the utility.

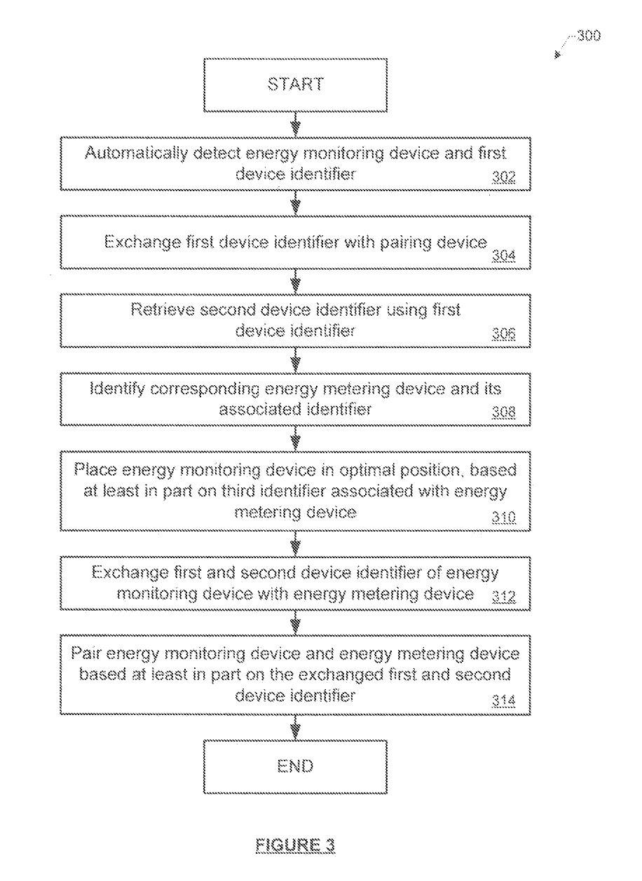

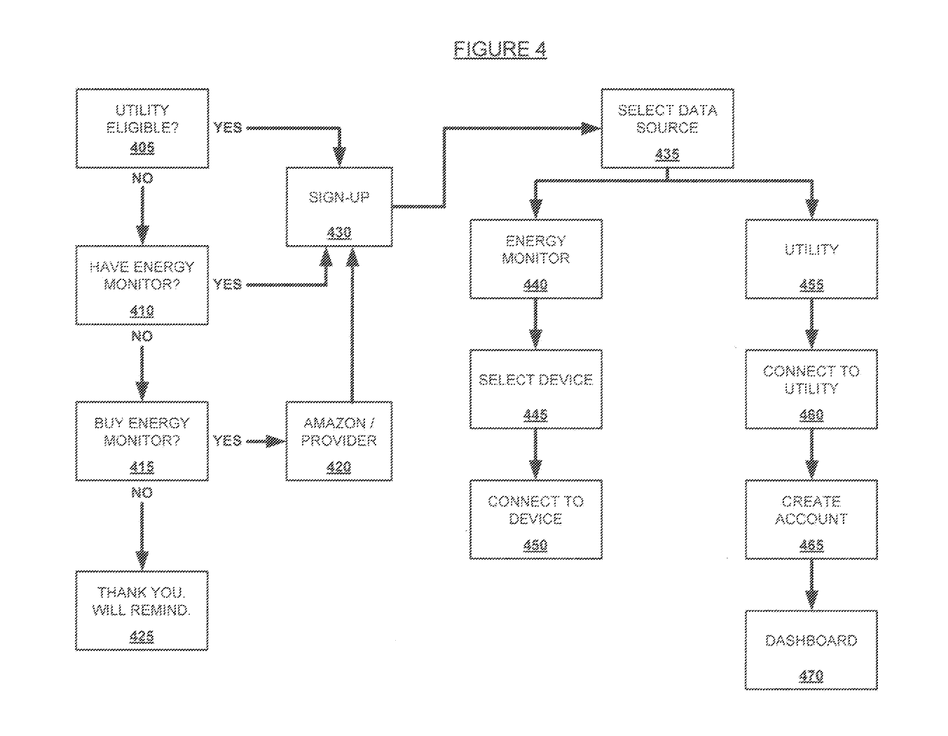

With reference to FIG. 3, an exemplary method 300 for facilitating simplified pairing between energy monitoring device and energy metering device in accordance with some embodiments of the present invention will now be discussed. The method begins at step 302, wherein an energy disaggregation pairing device may automatically detect an energy monitoring device. Such detection may occur, for example, either when requested or directed, or when the pairing device is powered on and connected to internet. Automatic detection of the energy metering device may be performed by a number of methods, including but not limited to (i) matching WAN IP addresses; (ii) using an OCR scan of a device label or associated documentation; and/or (iii) scanning an indicia, such as but not limited to a QR code, that is on a device label or accompanying documentation. Each of these is discussed in detail below.

When an energy monitoring device automatically detects the energy metering device through matching WAN IP addresses, the process may generally comprise matching a WAN-IP address (a wide area network IP, also known as public IP) to a customer registered with an energy utility. For example, energy monitoring device and other user devices associated with a user may be utilizing the same home area network to communicate, and accordingly may appear to have the same public IP address.

For example, an observed public IP address of a user device associated with a customer account may be stored in a database or data store accessible by a processor, third party, utility, or energy disaggregation pairing device. When an energy monitoring device is activated, it may similarly use the same WAN-IP, and accordingly be using the same assigned public IP address. Accordingly, if the customer's information stored in a database is associated with the public IP address, the identity of the customer may be determined and associated with the energy monitoring device. Note that systems and methods in accordance with some embodiments of the present invention may have associated MAC codes or install codes that may be used in the automatic pairing.

Alternatively, an energy monitoring device may automatically detect the energy metering device through using an OCR scan of a device label or associated documentation. This process is discussed above with regard to FIG. 1. Alternatively, a QR code or other indicia may be scanned and provided. The QR code or other indicia may include a device identifier (such as but not limited to a MAC address) associated with the energy monitoring device.

Once the first device identifier (e.g., the MAC address) associated with the energy monitoring device is identified, such identifier may be exchanged with an energy disaggregation pairing device at step 304. Energy disaggregation pairing device may be in selective communication with, or be associated with a database or data store. Such database or data store may be maintained by a utility, a third party, or an entity associated with the energy disaggregation pairing device. The database may be utilized to retrieve, based upon the first device identifier, a corresponding second device identifier (i.e., an install code) at step 306. Through such process, both the first device identifier (i.e, the MAC address) and the second device identifier (i.e. the install code) may be automatically retrieved without a customer or user having to manually input such identifiers.

As noted above, exchanging a first device identifier associated with an energy monitoring device may, in accordance with some embodiments of the present invention, comprise optically recognizing information labeled on, or associated with the one energy monitoring device. Based at least in part upon such optical recognition, the first identifier may be extracted or otherwise obtained. For example, a label of an energy monitoring device may be scanned or photographed by a device, such as but not limited to the energy metering device, and the first identifier may be extracted or otherwise obtained from the label or associated documentation.

After the energy monitoring device is detected the energy disaggregation pairing device may identify a corresponding energy metering device, via or along with the identifier of the energy metering device at step 308.

At step 310, an energy monitoring device may be placed in an optimal position with respect to the energy metering device so that the two (2) devices may be properly paired. It may occur that the location in which an energy monitoring device s installed may not be optimal, convenient, or desirable by a customer or user. In such situations, users or customers may move the energy monitoring device to a different location to optimize connectivity.

There are numerous ways to confirm that the two devices are positioned such that proper and/or optimal communications between the two devices are enabled. In accordance with some embodiments of the present invention, a device identifier of the energy metering device may be determined, for example using a configuration or provisioning API or by scraping a user's or customer's utility account. Such identifier may be sent to the energy monitoring device. Such communication may be sent using an alternative or additional communication network if it is sent before the energy monitoring device and the energy metering device are paired. A powered and activated energy monitoring device may attempt to send a beacon request to the energy metering device, and if such beacon is received from the energy metering device, a response may be sent. Such response may comprise the identifier for confirmation of proper pairing, and signal strength for communications between the devices may be determined. Based on the signal strength, a user or customer may be instructed to move the location of the energy monitoring device, for example by locating it more proximate to the energy metering device. In accordance with some embodiments, the signal strength may be displayed visually, for example using varying shades of brightness of a light emitting diode (LED), a speed at which an LED flashes, or varying colors of an LED (i.e., red may indicate the devices are out of range, green may indicate the devices are within range).

At step 312, the first device identifier, and the second device identifier of the energy monitoring device may be exchanged with the energy metering device. Such exchange may be conducted or processed by, or assisted by, an energy disaggregation pairing device.

At step 314, energy monitoring device and the energy metering device may be paired based at least in part on the exchanged first and second device identifier. Once paired, the energy monitoring device may begin to communicate directly with the energy metering device. Such communications may comprise high resolution data in real-time or near real-time.

Stated differently, the energy monitoring device may connect to the internet, display its IP address, and contact the energy disaggregation pairing device. The energy disaggregation pairing device may additionally sense or identify the unregistered device, and may associate the energy monitoring device with other devices transmitting from the same IP address, such as but not limited to other devices that may be used by a user to access the energy disaggregation pairing device.

For example, the energy monitoring device may be associated with a user's computer or smartphone. The energy disaggregation device may determine the energy metering device by using a configuration or provisioning API or scraping user's utility account, and may pair the energy monitoring device with the energy metering device. The energy disaggregation pairing device may detect failed pairing attempts, and may retry the pairing process if required. A user or customer may be notified of successful pairing.

In accordance with some embodiments of the present invention, a visual or sound indicator may identifies one or more errors with pairing or data transfers, such as zero and/or negative readings in installation for energy sensors based on CT, IR or optical sensing technology at the time and place of the installation. For example a CT clamp or optical/IR sensor may comprise an LED that may flash when a valid energy pulse is detected. Accordingly, a user or customer may be presented with immediate feedback without having to check different locations.

With reference to FIG. 4, an exemplary method of registration of an energy monitoring device and an energy metering device with an energy utility is shown in accordance with some embodiments of the present invention. This process may include aspects of automatically identifying the energy monitoring device and identifying and associating a user's energy utility account with the energy monitoring device and appropriate energy metering device.

At step 405 it may be determined if the utility that provides services to the customer is eligible for a direct connection with the energy disaggregation pairing device. If so, the user may, at step 430, be encouraged to sign-up for the energy utility products and/or services. If not, at step 410 the user may be queried as to whether the user has an energy monitoring device. If the user has the energy monitoring device, the user may again be encouraged to sign up at 430. If not, the user may be queried to determine if the user would like to purchase an energy monitoring device at 415. If the customer would not like to purchase the energy monitoring device, then the flow may terminate at 425, where the user may be thanked for his or her interest, and note that the user may be reminded in the future to sign-up.

If the user desires to purchase an energy monitoring device, the user may do so at 420, where the user may be connected to, or advised to connect with, a provider of an energy monitoring device, such as Amazon.com®. In accordance with some embodiments of the present invention, the user may be advised to purchase an energy monitoring device compatible with the determined energy metering device. Once the energy monitoring device is purchased, the user may again be encouraged to sign up at step 430.

Once signed up, at step 435 the user may identify the data source for the services and products. At step 440 the user may select to use the energy monitoring device as the data source (or as a data source in conjunction with utility data). At step 445, the energy monitoring device may be selected. At step 450 the energy disaggregation pairing device may connect to the energy monitoring device. The energy disaggregation pairing device may then connect to the energy utility at step 460.

The user may also elect at step 455 to use the utility as a data source (in the case of an eligible utility). At step 460 the energy disaggregation pairing device may connect to the energy utility.

At step 465 an account may be created, which may comprise a variety of information which may include information sufficient to identify the proper energy metering device, the energy monitoring device, and the user's account with the utility (to identify at least rate plans, billing cycles, etc.). Note that an account may not be required. Moreover, if an account previously exists, such account can be linked. Otherwise, if no account exists, the user may be given the option to create an account and then proceed with linking the information. At step 470 the user may be presented with a dashboard or other interface from which the user may view its information. Note that the in accordance with some embodiments of the present invention, the user may also (rather than step 460) connect to his or her utility account via a third party analytics website that is already paired with the energy monitoring device and/or energy metering device.

In some embodiments, an image of the energy bill associated with at least one household may be captured. A user account and/or an energy rate structure may be determined based on the captured image or textual information extracted from the captured image. Such energy rate structure and user account information may be transmitted to an energy disaggregation pairing device.

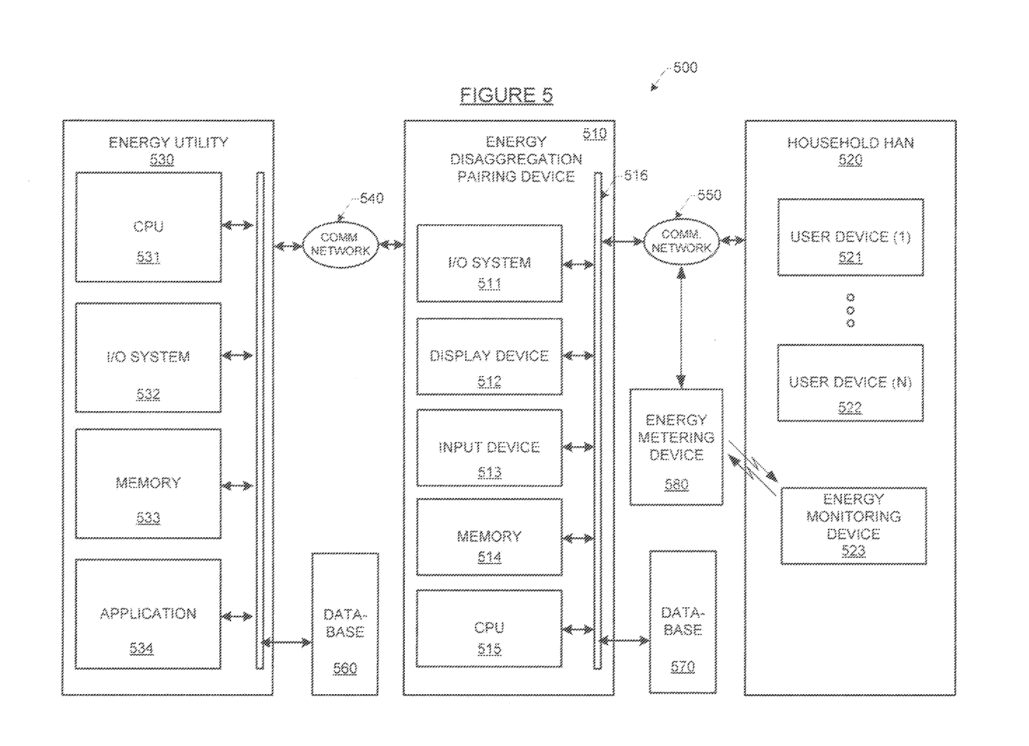

Referring to FIG. 5, in accordance with some embodiments of the present invention, an exemplary environment 500 for managing the energy usage in a household will be discussed. In general, exemplary environment 500 may comprise an energy disaggregation pairing device 510 in communication with energy utility 530. The energy disaggregation pairing device 510 may communicate with the energy utility 530 via one or more communication networks 540. Note that it is also contemplated that the energy disaggregation pairing device 510 may interact with customer devices 521, 522 and/or energy monitoring device 523 using a communication network 550 or using other methods or techniques. For example, it is contemplated that the energy disaggregation pairing device 510 may interact with the customer devices 521, 522 and energy monitoring device 523 via a home area network (HAN) 520 within a specific household. Similar communications networks may be utilized to communicate with energy metering device 580. Energy metering device 580 may comprise, for example, a Smart Meter.

Communication networks 540, 550 may include the internet, local area networks (LAN), wide area network (WAN), virtual private networks (VPN), 3G technologies, GPRS, and/or EDGE technologies, although the communication networks 540, 550 may comprise other types and numbers of networks and topologies. In addition, note that it is contemplated that in accordance with some embodiments of the present invention, the energy disaggregation pairing device 510, energy monitoring device 523, and/or energy metering device 580 may communicate through a short range wireless communication link, such as a Zigbee™ link, Bluetooth, NFC, and/or other short range communications.

Note that while not shown, the exemplary environment 500 may include additional components, such as but not limited to routers, switches and other devices which are well known to those of ordinary skill in the art and thus will not be described here.

In general, energy disaggregation pairing device 510 may facilitate pairing of energy metering device 580 with energy monitoring device 523 and/or customer accounts at utility 530. However, note that the energy disaggregation pairing device 510 may also perform other types and numbers of functions and operate in other types of networks.

Energy disaggregation pairing device 510 may comprise various components. Such components may include some or all of: an input/output (I/O) system 511, a display device 512, an input device 513, a memory 514, and/or a central processing unit (CPU) 515. Such components may be connected or in communication with each other through a bus 216. Although it is contemplated that bus 216 may comprise a hyper-transport bus, other bus types and/or links may be used, such as but not limited to a PCI (peripheral component interconnect) system. Note that the energy disaggregation pairing device 510 may also comprise other types and numbers of elements in various configurations. Each component is discussed below.

The I/O system 511 in the energy disaggregation pairing device 510 may be used to operatively couple and communicate between the energy disaggregation pairing device 510 and the customer devices 521, 522, which may be coupled together or in selective communication via communication network 550. The I/O system 511 may work in connection with display device 512 and input device 513 to provide for customer interaction with the energy disaggregation pairing device 510.

The display device 512 may enable a customer to interact with the energy disaggregation pairing device 510, such as to view information, input information, configure the device, program the device, and/or operate the device. By way of example only, the display device 512 may include one or more of a CRT, LED monitor, LCD monitor, or touch screen display technology although other types and numbers of display devices may be used.

Energy disaggregation pairing device 510 may also include an input device 513 that may, for example, enable a customer to interact with energy disaggregation pairing device 510, such as to input data, view data, configure the device, program the device, and/or operate the device. By way of example only, input device 513 may include one or more of a touch screen, keyboard and/or a computer mouse.

The memory 514 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. In accordance with some embodiments of the present invention, memory 514 may store one or more programmed instructions such that the CPU 515 may execute the program, processes and/or methods.

CPU 515 may comprise one or more one or more processing cores, such as AMD® or Intel® processors, and may be configured to execute one or more computer-executable instructions stored in a memory 514, although it is contemplated that the CPU 515 may also execute other types and numbers of instructions and perform other types and numbers of operations.

The exemplary environment 500 may further comprise a specific household, which may include or comprise a plurality of customer devices 521, 522 connected via a HAN 520, disposed in a household. Energy disaggregation pairing device 510 and the customer devices 521, 522 within a specific household may be in selective communication via communication network 550.

Energy utility 530 may be in selective communication with energy disaggregation pairing device 510 via communication network 540. Communication network 540 may comprise any sort of network or connection, similar to as discussed above with regard to communication network 550. Energy utility 530 may include a central processing unit (CPU) or processor 531, an input/output (I/O) system 532, a memory 533, and an application that may operate as an interface system 534. Such components may be coupled together by a bus or other link, although other numbers and types of network devices could be used.

Energy utility 530 may also further comprise, or have access to, database 560. Database 560 may comprise one or more data stores, and may comprise information such as, but not limited to, various pricing structures for specific customers, entire energy profiles of a customer (i.e., aggregated data), which may be received, for example, from a Smart Meter, disaggregated data, and/or historical patterns of energy use and/or associated costs for specific customers.

Although the exemplary environment 500 includes energy disaggregation pairing device 510, a specific household HAN 520 with multiple customer devices 521, 522, and energy utility 530 as described and illustrated herein, other types and numbers of systems, devices in other topologies may be used. It is to be understood that the systems of the examples described herein are for exemplary purposes, as many variations of the specific hardware and software used to implement the examples are possible, as will be appreciated by those skilled in the relevant art(s).

A description of an embodiment with several components in communication with each other does not imply that all such components are required. On the contrary a variety of optional components are described to illustrate the wide variety of possible embodiments of the invention. When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of pairing of an energy monitoring device with an energy metering device with limited user action, the method transacted using an energy disaggregation pairing device in communication with the energy monitoring device and the energy metering device, the method comprising:
detecting, using the energy disaggregation pairing device, the energy monitoring device and at first monitor device identifier associated therewith;
retrieving, using the energy disaggregation pairing device, a second monitor device identifier associated with the energy monitoring device, based at least in part on the first monitor device identifier;
identifying by the energy disaggregation pairing device, the energy metering device and a metering device identifier associated therewith;
providing by the energy disaggregation pairing device, the first monitor device identifier and the second monitor device identifier to the identified energy metering device; and
pairing by the energy disaggregation pairing device, the detected energy monitoring device with the identified energy metering device.

2. The method of claim 1, wherein the first monitor device identifier comprises information associated with the energy monitoring device, such information being optically recognized.

3. The method of claim 2, wherein the first monitor device identifier is detected by extracting the first monitor device identifier from the optically recognized information.

4. The method of claim 3, wherein the first monitor device identifier is a MAC address or a wide area network (WAN) internet protocol (IP) address.

5. The method of claim 1, wherein the first monitor device identifier is detected by matching the first monitor device identifier with a WAN-IP or public IP address of a user device.

6. The method of claim 1, wherein the detecting the first monitor device identifier comprises:
scanning a label of the at least one energy monitoring device; and
extracting the first monitor device identifier from the scanned label.

7. The method of claim 1, further comprising:
sending, by the energy disaggregation pairing device, the metering device identifier to the energy monitoring device;
transmitting, by the energy monitoring device, a beacon request in response to receiving the metering device identifier;
receiving, by the energy monitoring device, a beacon response including metering device identifier, the beacon response indicative of signal strength;
providing an indication of signal strength to a user, such that the user may utilize the indication of signal strength to optimally position the energy monitoring device.

8. The method of claim 1, further comprising:
communicating, by the energy monitoring device, real time high resolution data to the identified energy metering device.

9. The method of claim 1, further comprising registering the energy monitoring device and the energy metering device with an energy utility.

10. The method of claim 9, further comprising identifying a customer account with the energy utility and identifying any applicable energy rate structure and/or billing cycle.

11. The method of claim 1, further comprising:
capturing an image of an energy bill or communication associated a customer account with an energy utility;
determining an applicable energy rate structure for the customer account based at least in part on the captured image;
identifying the customer account based at least in part on textual information extracted from the captured image.

12. The method of claim 1, wherein the first monitor device identifier comprises a media access control (MAC) code.

13. The method of claim 1, wherein the second monitor device identifier comprises an install code.

14. The method of claim 1, wherein the metering device identifier comprises a MAC code.

15. The method of claim 1, further comprising:
determining issues associated with the energy metering device, energy monitoring device, or pairing of the energy metering device and energy monitoring device; and
attempting to re-pair the energy metering device with the energy monitoring device.

16. The method of claim 15, wherein the issues comprise erroneous installations, missing data reads, zero reads, and/or negative reads.

17. An energy disaggregation pairing device comprising:
one or more hardware processors;
a memory coupled to the one or more hardware processors storing instructions, that when executed by the one or more hardware processors, causes the one or more hardware processors to perform operations comprising:
detecting, using the energy disaggregation pairing device, the energy monitoring device and at first monitor device identifier associated therewith;
retrieving, using the energy disaggregation pairing device, a second monitor device identifier associated with the energy monitoring device, based at least in part on the first monitor device identifier;
identifying by the energy disaggregation pairing device, the energy metering device and a metering device identifier associated therewith;
providing by the energy disaggregation pairing device, the first monitor device identifier and the second monitor device identifier to the identified energy metering device; and
pairing by the energy disaggregation pairing device, the detected energy monitoring device with the identified energy metering device.

18. The device of claim 17, wherein:
the first monitor device identifier comprises a media access control (MAC) code associated with the monitoring device;
the second monitor device identifier comprises an install code associated with the monitoring device; and
the metering device identifier comprises a MAC code associated with the metering device.

19. A non-transitory computer readable medium storing instructions for simplifying pairing of at least one energy monitoring device with at least one metering device, that when executed by the one or more hardware processors, cause the one or more hardware processors to perform operations comprising:
detecting, using the energy disaggregation pairing device, the energy monitoring device and at first monitor device identifier associated therewith;
retrieving, using the energy disaggregation pairing device, a second monitor device identifier associated with the energy monitoring device, based at least in part on the first monitor device identifier;
identifying by the energy disaggregation pairing device, the energy metering device and a metering device identifier associated therewith;
providing by the energy disaggregation pairing device, the first monitor device identifier and the second monitor device identifier to the identified energy metering device; and
pairing by the energy disaggregation pairing device, the detected energy monitoring device with the identified energy metering device.
